(19) United States
(12) Patent Application Publication
(10) Pub. No.: US 2009/0064662 A1
(43) Pub. Date: Mar. 12, 2009

(54) METHOD FOR MOUNTING A PROBE TO AN EXHAUST GAS TREATMENT DEVICE

(76) Inventors: Markus Kontz, Saarbrucken (DE); Bernd Muller, Spicheren (FR)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/204,295

(22) Filed: Sep. 4, 2008

(30) Foreign Application Priority Data
Sep. 6, 2007 (DE) 10 2007 042 281.6

(51) Int. Cl. F01N 11/00; B23P 11/00

(52) U.S. Cl. 60/276; 29/428

(57) ABSTRACT

The present invention relates to a method for installing a probe (6) on an exhaust gas treatment device (1), which has at least one ceramic insert (3) secured in a metallic housing (2) by means of a bearing mat, with which a receptacle opening (7) for receiving the probe (6), penetrating through the housing (2) and the bearing mat (5) and into the insert is created when the insert (3) has already been inserted into the housing (2) and secured there with the bearing mat (5).

With a number of exhaust gas treatment devices, e.g., particulate filters and catalytic converters, it is desirable to mount at least one probe, e.g., a lambda probe or an NOX probe. Conventional exhaust gas treatment devices include at least one ceramic insert which is secured with the help of a bearing mat in a metallic housing. To be able to install a probe with such an exhaust gas treatment device, a receptacle opening that passes through the housing and the bearing mat into the insert is required. Then the probe can be inserted into this receptacle opening.

To manufacture such a receptacle opening, it is fundamentally possible to introduce a corresponding opening into the housing before inserting the insert and the bearing mat. Likewise, a corresponding opening can be introduced into the insert before insertion into the housing. Furthermore, a corresponding recess can also be introduced into the bearing mat before bending the insert. On bending the insert with the bearing mat, the recess in the bearing mat and the opening in the insert must be positioned and aligned accurately with respect to one another. In the subsequent insertion of the insert with the bent bearing mat into the housing, the so-called “canning,” an alignment of the different openings and/or recesses in the housing, bearing mat and insert must also be maintained. The alignment of the openings and/or recesses in canning must be performed comparatively carefully on the one hand while on the other hand is subject to tolerance. Furthermore, the ceramic insert must be secured in a relatively complicated manner for insertion of the opening in order to avoid damage to the comparatively brittle insert.

Methods for introducing openings into a metal body are known from DE 10 2004 013 640 A1, FR 2 851 486 A1, DE 42 24 131 A1, EP 1 364 724 A1 and DE 103 20 140 A1.

The present invention relates to the problem of providing an improved embodiment for a method of the type defined in the preamble which is characterized in particular by the fact that production is simplified and/or narrower tolerances can be achieved and/or a better alignment within the receptacle opening can be achieved.

This problem is solved according to the present invention through the subject matters of the independent claims. Advantageous embodiments are the subject matter of the dependent claims.

The invention is based on the general idea of installing the receptacle opening only when the insert has already been secured in the housing by means of the bearing mat. The respective receptacle opening is then installed from the outside so that it passes through the housing and the bearing mat and penetrates into the insert. This procedure necessarily results in an optimal alignment between the individual openings and/or recesses in the housing, in the bearing mat and in the insert. With this procedure, it is particularly advantageous that the insert is adequately secured in the housing to be able to create the opening in the insert without there being any increased risk of damage to the insert. To this extent, it is possible to omit a separate attachment of the insert for the production of the receptacle opening. On the whole, this thus yields a simplified method of manufacturing the receptacle opening.

An embodiment in which the receptacle opening is created by means of a drilling operation and/or by means of a machining operation is especially advantageous. This procedure is especially gentle from the standpoint of the ceramic insert, so the risk of damage to the insert is reduced.

Additional important features and advantages of the invention are derived from the dependent claims, the drawings and the respective description of the figures on the basis of the drawings.

It is self-evident that the features mentioned above and those yet to be explained below may be used not only in the particular combination given but also in other combinations or alone without going beyond the scope of the present invention.

Preferred exemplary embodiments of the invention are depicted in the drawings and explained in greater detail in the following description, where the same reference numerals are used to refer to the same or similar components or those having the same function.

In figures schematically:

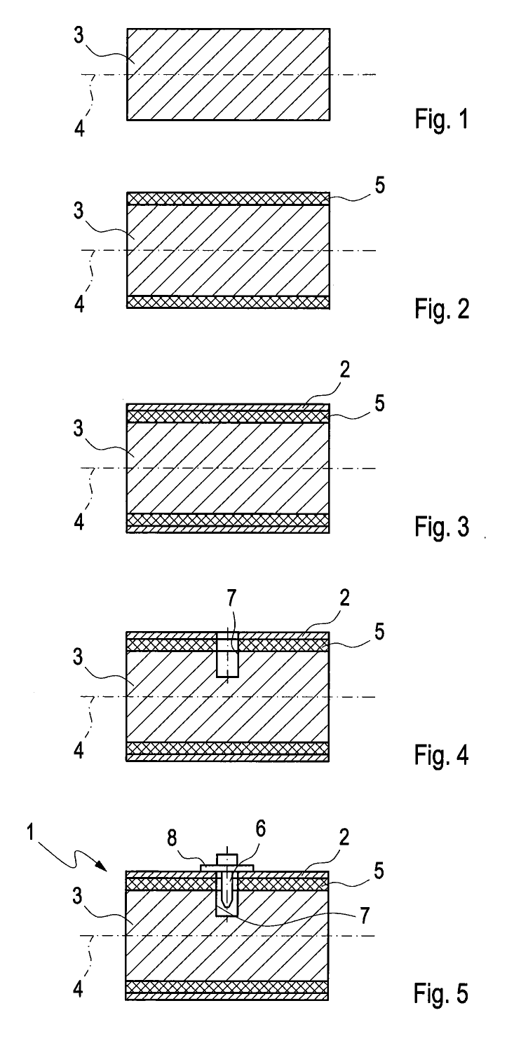

FIGS. 1 to 5 each show a greatly simplified longitudinal section through a part of an exhaust gas treatment device in different phases during the installation of a probe.

According to FIG. 5, an exhaust gas treatment device 1 comprises a housing 2, shown here only partially. The housing 2 is made of metal and is preferably a tubular body which is closed in the circumferential direction. This is usually a molded sheet metal body. The housing 2 may have a funnel on at least one axial end. The exhaust gas treatment device 1 also has at least one insert 3 which is manufactured from a ceramic material. This may be a monolithic insert 3. Likewise, the insert 3 may be assembled for multiple monoliths. The exhaust gas treatment insert 1 may be designed as a catalyst, for example, in which case the respective insert 3 then functions as a carrier or substrate for a corresponding catalyst material. Likewise, the exhaust gas treatment device 1 may be a particulate filter, for example, in which case the respective insert 3 then has the filter function. The insert 3 usually has a plurality of parallel channels (not shown here) which extend parallel to a central longitudinal axis 4 of the exhaust gas treatment insert 1.

The respective insert 3 is secured in the housing 2 with the help of at least one bearing mat 5. The bearing mat 5 surrounds the insert 3 in the circumferential direction, usually in one layer. Likewise, a multilayer sheathing is also conceivable. The bearing mat 5 serves to provide thermal insulation for the housing 2 with respect to the insert 3, which is exposed to comparatively high temperatures during operation of the exhaust gas system in which the exhaust gas treatment insert 1 is installed. In addition, the bearing mat serves to support the insert 3 in the housing 2 with vibration damping to reduce the risk of damage to the relatively brittle insert 3 due to vibrations which may occur during operation of a vehicle equipped with such an exhaust system, for example. In addition, the bearing mat 5 serves to secure the position of the insert 3 in the housing 2. To do so, the bearing mat 5 is pressed radially between the insert 3 and the housing 2 with respect to the central longitudinal axis 4. Due to the elastic restoring forces in the material of the bearing mat, the result is then a radial prestress which creates sufficient holding forces to secure the insert 3 in the housing 2.

According to FIG. 5, the exhaust gas treatment device 1 has at least one probe 6 which is accommodated in a receptacle opening 7. The probe 6 may be, for example, a lambda probe or an oxygen probe or an NOX probe or a temperature probe or a pressure probe or the like. The receptacle opening 7 passes through the housing 2 and also through the bearing mat 5. Furthermore, the receptacle opening 7 penetrate into the insert 3. The probe 6 protrudes into the receptacle opening 7 and/or the probe 6 is inserted into the receptacle opening 7. A fitting 8, which is attached to the housing 2 may be provided to hold the probe 6 on the exhaust gas treatment insert 1.

A method for mounting the probe 6 on the exhaust gas treatment device 1 is explained in greater detail below.

First, the insert 3 is inserted into the housing 2 in the usual way according to FIGS. 1 to 3 and is secured there with the help of the bearing mat 5. In this so-called canning, the insert 3 shown in FIG. 1 is first sheathed along its circumference with the help of the bearing mat 5 according to FIG. 2 in the case of a tubular housing 2. Then the insert 3 is inserted together with the bearing mat sheathing it into the housing 2 in the axial direction. This may be accomplished in various ways. First, the housing 2 may first have an enlarged diameter, so that the insert 3 with the bearing mat 5 can be inserted into the housing 2 comparatively easily, i.e., parallel to the central longitudinal axis 4. Next, the housing 2 may then be reshaped in such a way that its diameter is reduced. This results in the desired pressing of the bearing mat 5. Alternatively, it is also possible to introduce the insert 3 together with the bearing mat 5 into the housing 2 by means of a funnel or the like, for example, with the bearing mat 5 compressed.

As soon as the insert 3 is arranged in the housing 2 and is secured there by the bearing mat 5 which is pressed radially, the condition illustrated in FIG. 3 prevails.

According to this invention, the receptacle opening 7 is then created according to FIG. 4 when the insert 3 has already been secured in the housing 2 with the help of the bearing mat 5. For example, a traditional machining operation may be used here. The receptacle opening 7 may preferably be drilled or milled. It is especially advantageous here for only the housing 2 to have to be secured in a corresponding tool to create the receptacle opening 7. A separate or additional attachment of the bearing mat 5 and/or the insert 3 is not necessary because both the bearing mat 5 and the insert 3 are adequately secured in the housing 2 because of the radial pressure of the bearing mat 5 between the insert 3 and the housing 2. This facilitates the creation of the receptacle opening 7. Furthermore, due to this more or less subsequent introduction of the receptacle opening 7, this automatically results in an optimal and flush alignment of the individual partial openings in the housing 2, in the bearing mat 5 and in the insert 3 relative to one another.

According to FIG. 5, the fitting 8 may then be attached to the housing 2 on the outside. For example, the fitting 8 may be soldered to the housing 2 or welded to the housing 2. Essentially other fastening methods are also conceivable. The fitting 8 is designed so that the probe 6 can be secured in it, so that the probe 6 protrudes into the receptacle opening 7 for a sufficient distance. For example, the fitting 8 may therefore have a thread (not shown here) into which the probe 6 can be screwed.

With the embodiment shown here, the receptacle opening 7 is oriented radially with respect to the central longitudinal axis 4. It is clear that essentially any other orientation is also conceivable.

1. A method for mounting a probe on an exhaust gas treatment device, said treatment device having at least one ceramic insert that is secured in a metallic housing by means of at least one bearing mat wherein a receptacle opening that penetrates through the housing and the bearing mat into the insert is created to receive the probe when the insert has already been inserted into the housing and secured therein with the bearing mat.

2. The method according to claim 1, wherein the receptacle opening is created by a drilling operation and/or by a machining operation.

3. The method according to claim 1, wherein a fitting is attached to the housing on the outside and the probe can be secured on the fitting in such a way that it protrudes into the receptacle opening.

4. The method according to claim 3, wherein the fitting is soldered or welded to the housing.

5. The method according to claim 3, wherein the fitting has a thread into which the probe is screwed.

6. The method according to Claim 1, wherein the receptacle opening is oriented radially with respect to a central longitudinal axis of the exhaust gas treatment insert.

7. An exhaust gas treatment device, in particular a particulate filter or catalytic converter for an exhaust gas system of an internal combustion engine, in particular in a motor vehicle, having at least one ceramic insert, which is secured in a metallic housing by means of at least one bearing mat, wherein at least one receptacle opening is provided, serving to receive a probe, which penetrates through the housing and the bearing mat and penetrates into the insert and which has already been created when the insert has already been inserted into the housing and secured there with the bearing mat.
